(19) United States
(12) Patent Application Publication
(10) Pub. No.: US 2012/0197594 A1
(43) Pub. Date: Aug. 2, 2012

(54) METHOD FOR FILTERING MEASUREMENT SIGNALS

(75) Inventors: Thomas Orth, Mulheim (DE); Stefan Nitsche, Mulheim (DE); Till Schmitte, Bochum (DE); Klaus-Dieter Müller, Mulheim (DE)

(73) Assignee: V & M Deutschland GMBH, Dusseldorf (DE)

(21) Appl. No.: 13/382,046

(22) PCT Filed: Jun. 23, 2010
(86) PCT No.: PCT/DE2010/000735

§ 371 Date: Mar. 16, 2012

(30) Foreign Application Priority Data
Jul. 3, 2009 (DE) 102009032100.4

(51) Int. Cl. G06F 17/18

(52) U.S. Cl. 702/179

(57) ABSTRACT

The invention relates to a method for filtering measurement signals by way of wavelet filtering, wherein the signals are first transferred to the wavelet domain by way of a wavelet transform, are subjected to threshold analysis, and the threshold values can then be varied in the wavelet domain commensurate with the respective measurement situation. The measurement signals are filtered by a plurality of filters arranged in segmentation levels and a statistical parameter is calculated based on an adjustable number of already calculated wavelet coefficients of a segmentation level and is then multiplied with a value that can be adjusted.

The invention relates to a method for filtering measurement signals according to the preamble of claim 1.

Filtering of measurement signals is used, for example, in nondestructive material testing during the production of pipes from metal for testing for surface flaws or wall thickness deviations. The ultrasound or leakage flux testing is hereby employed which is known in the art and has proven successful over time.

The tests are used during production to control in particular the compliance of the required wall thickness of the pipe and to detect flaws present in the pipe wall, for example lamination flaws, cracks, notches, rolling inclusions or other surface flaws.

When performing ultrasound testing with the pulse echo method, ultrasound pulses are excited in the wall starting from the exterior surface of the pipe, and the signals reflected at the interior surface of the pipe are received again. The thickness of the pipe wall can be computed from the transit time of the signals and from the sound velocity in the material to be tested. This method is typically employed during the production and is automated for both magnetizable and non-magnetizable pipe materials.

In the measurement technology a distinction is generally made between useful signals and interfering signals. The useful signals are hereby the desired carriers of information, on which interfering signals, for example background noise, are superimposed. The ratio of (useful) signal S (=signal) to interfering signal N (N=noise) is referred to as S/N ratio. The greatest attainable S/N ratio is usually desirable in order to achieve high test sensitivity.

The nondestructive test has the disadvantage that when using the typical evaluation methods of signals, flaws cannot always be uniquely detected, in particular under unfavorable circumstances relating to the position of the surface flaws and geometry of the tested piece. The separation between flaw detection and noise level is then too small to provide meaningful information.

For evaluating signals in nondestructive material testing, novel filter techniques based on wavelet algorithms are increasingly used to separate signals caused by flaws from the basic noise level.

In addition to digital filter techniques with conventional filtering algorithms, wavelet algorithms are particularly suitable for this task. Wavelets are used as filter criteria instead of harmonic functions due to their great similarity with the useful signals. Noise can be significantly more effectively suppressed with wavelet filters compared to conventional filter techniques.

in general, wavelet filtering is a technique similar to a Fourier transformation, wherein a signal is transformed from the time domain to a frequency domain. Whereas the Fourier transformation completely suppresses the time information, a part of the time information is retained with the wavelet transformation into the wavelet domain, yielding information about the frequency of a signal at a specific point in time. A similar result can also be attained with the so-called “short time Fourier transformation.”

In contrast to the Fourier transformation, harmonic functions (sin/cos) are not used as orthogonal system of functions in the wavelet transformation, and short pulse-shaped “wavelets” are used instead. The signal is then convoluted with these wavelet base functions in the wavelet transformation.

It can be shown that this process can be represented as a specific sequence of FIR (“finite impulse response”) filters. In addition, this algorithm can be viewed as application of a specific matrix on the signal, wherefrom the known “fast wavelet transformation” (FWT) algorithm results. This algorithm includes continuous omission (“down-sampling”) of redundant information and blocking the data flow. These last two properties of the FWT are viewed as being disadvantageous for nondestructive testing. On one hand, blocking the data at the boundaries of the data flow causes undesirable artifacts. On the other hand, the aforementioned “down-sampling” does not result in stationary signal characteristics.

After the wavelet transformation, the computed wavelet coefficients are subjected to a threshold evaluation. This means that the wavelet coefficients are compared with a threshold value and changed according to a method to be defined, e.g. “soft-thresholding.” These modified wavelet coefficients are then supplied to an inverse wavelet transformation. The entire process is referred to as wavelet filtering.

For separating noise and information components of signals in monitoring industrial processes, it is generally known, for example from DE 102 25 344 A1, to use wavelet transformations for evaluating time-dependent signals. With the wavelet transformation, the original signal is projected onto wavelet base functions, which represents mapping from the time domain to the time-frequency plane. The wavelet of functions which are localized in the time and frequency domain, are derived from a single prototype wavelet, the so-called mother function, by dilatation and translation.

The wavelet transformation attempts to decrease the noise level compared to the signal from a flaw.

WO 2005/012941 discloses a method for nondestructive testing of objects with ultrasound waves, whereby the amount of data is reduced or compressed with a wavelet transformation. Error suppression or signal separation is not performed.

DE 10 2005 036 509 A1 discloses a method for nondestructive testing of pipes for surface flaws, wherein the measurement signals are evaluated in real time with a special type of filtering and processing of the data. The analog signals are hereby transformed into a continuous data stream of digital data and supplied via additional processing steps to a digital signal processor and a higher-level data processing system.

However, these conventional methods have the disadvantage that the threshold values in the wavelet domain for filtering the measurement signals are either determined with conventional mathematical methods or must be determined experimentally and are thus fixedly defined. The experimental determination is very complex and not universally valid. The mathematical methods do not always produce satisfactory results in practice, because the assumptions for deriving these threshold values (assumption: white noise as an interfering signal) are not always true, leading to unsatisfactory results when separating the signal from noise.

It is therefore an object to provide a reliable and cost-effective method for filtering measurement signals, wherein the threshold values in the wavelet domain can be variably changed depending on the respective measurement situation, thereby optimally separating the measurement signals from noise.

This object is attained according to the invention by calculating a statistical variable from a pre-definable number of already computed wavelet coefficients of a segmentation level and by multiplying the statistical valuable with a value that can be commonly set for all levels for determining a threshold value for this segmentation level.

The statistical parameter may hereby be, for example, a standard deviation from a mean, a standard deviation from a median, or the mean square deviation RMS (root mean square).

Advantageously, the wavelet filtering known from DE 10 2005 036 509 A1 which uses a continuous digital data stream can be used for this method, because the data history can then also be taken into account for determining the threshold value. In addition, the length of time during which the history is monitored can also be advantageously adjusted.

According to an advantageous embodiment of the invention, an additional parameter may also be provided which limits the maximum value of the difference between one threshold value and the following threshold value, so as to prevent excessive changes in the automatically computed threshold value much. This would otherwise produce an uneven filtering result.

In special situations, the so-called Approximation, which is normally left unchanged, may advantageously also be supplied to a threshold value evaluation or may even be set to a value of zero.

This approximation represents the longest-wavelength component of the signal, i.e. the background, which is computed by n-stage wavelet separation.

According to another advantageous embodiment of the invention, the computation algorithm for filtering is stopped during the measurement pauses by an additional signal, so that the data of the preceding measurement are available as history when the measurement is resumed.

According to the invention, the measurement signals are filtered with wavelet filters consisting of a cascaded arrangement of FIR (finite impulse response) filters. This arrangement is also referred to as a filter bank. With this structure, the signal is first transformed into the wavelet domain (also referred to as decomposition), wherein this process is comparable to the transformation into the frequency domain with a Fourier transformation.

The signal in the wavelet domain is composed of the wavelet coefficients which are present at different levels or stages. The number of stages corresponds to the depth of the cascaded FIR-filter arrangement.

According to the invention, the wavelet coefficients are changed in the wavelet domain by evaluating the amplitude of the wavelet coefficients within a stage. A positive threshold value is defined for each stage. Each coefficient is compared with this value. If the magnitude of the coefficient is smaller than the threshold value, then the coefficient is set to zero. If the magnitude is greater than the threshold value, then the threshold value is subtracted when the coefficient is positive and added when the coefficient is negative.

After this so-called soft-thresholding, the wavelet coefficients are again back-transformed into the time domain.

According to the invention, the so-called hard-thresholding is implemented in addition to the soft-thresholding. The wavelet coefficients above the thresholds “survive” in the corresponding stage without changing their value, whereas all coefficients below the threshold value are set to zero.

The back-transformation (also referred to as synthesis/reconstruction) is likewise performed with a cascaded filter structure. However, the filter coefficients are different from those in the forward transformation.

Unlike with conventional filter methods, of the so-called “stationary wavelet transformation” is employed according to the invention. In this case, the “down-sampling” after each stage used in the conventional “fast the wavelet algorithm” is eliminated. Although redundant signal components are then retained, the filtered signals however are no longer dependent on the position within the input signal (hence “stationary”).

Because the signals are quasi-infinite, this algorithm can be improved even further with the invention. An initial goal is to eliminate blocking of the data and to perform filtering continuously, meaning point-by-point. This approach prevents the generation of artifacts at the block boundaries (“block artifacts”) and is better adapted to the signal structure in nondestructive testing.

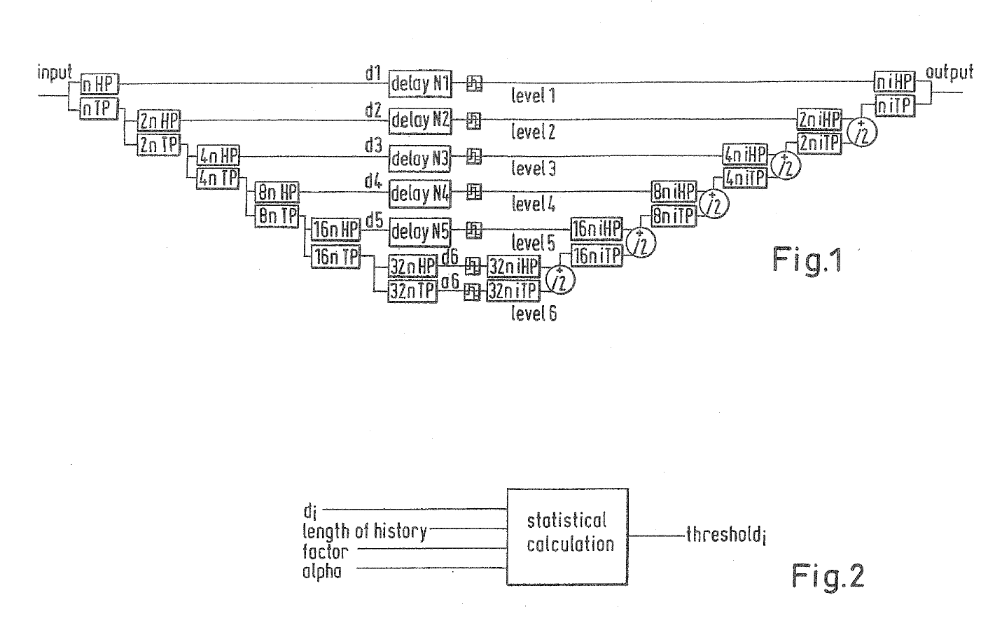

The cascaded structure according to the invention is illustrated in FIG. 1. In each stage, the input signal is transmitted through a pair of FIR filters, of which one is a high-pass (HP) and the other a low-pass (TP). The filters operate in a point-by-point mode, i.e., one output value is generated for each input value. Because each stage has two filters, the number of values is doubled in each stage.

The results of the HP filtering are stored in a corresponding FIFO (first in-first out) temporary storage device.

The wavelet coefficients are also referred to as “details” and are indicated with “d” and an index indicating the stage. For example, the first HP generates the detail d1. The wavelet coefficients d2 are generated in the second stage, etc. The results of the TP filtering are supplied to the next stage. The filter length is doubled in each stage through filling with zeros. For the Daubechies-4-wavelets, the first stage has an FIR HP and TP with four coefficients each; there are ten filter coefficients for Daubechies-10-wavelets. This filter is filled in the second stage at each position with zeros, so that the filter length of each of the HP and the TP is 8 (for Daubechies-4). The filter length is then 16 in the next stage, etc.

| | Filter | |
|---|---|---|
| Stage | length | Example for the FIR filter coefficients |
| 1 | 4 | abcd |
| 2 | 8 | a0b0c0d0 |
| 3 | 16 | a000b000c000d000 |

At the end of the cascade, the signals of the HP and TP filtering of the last stage “are left.” For six stages, the details d6 are present at the output of the 6^{th} HP filter. The results of the 6^{th} TP filtering are referred to as Approximation and abbreviated with a6. This Approximation represents the longest-wavelength component of the signal, i.e., the background which was computed by a filter bank of 6 TP filters.

After the wavelet separation, the wavelet coefficients are supplied to thresholding, as described above.

The back-transformation is also performed with FIR filters in an inverse structure, see FIG. 1.

Starting from the bottom, the wavelet coefficients a6 and d6 are supplied (after thresholding) to the inverse TP-(iTP) and inverse HP-(iHP) filters. These inverse filters of the last (6^{th}) stage have once more 128 FIR filter coefficients. Each individual result value of the two filters is added and divided by 2 (forming quasi an average value). This value is then the input value for the iTP filter of the next higher (5^{th}) stage. The input value of the iHP filters is taken from the FIFO of the corresponding stage.

The signal is then reassembled in the aforementioned manner to the filtered output signal. It is hereby important that each filter operates point-by-point, meaning that in each cycle a value is pushed through the entire schema from the left. Because a commensurately large number of values must be stored in the individual stages, the overall signal is delayed. This delay corresponds to the addition of the group transit times of a signal through the different filters. Due to the different filter length, a delay element (FIFO) needs to be placed between the separation FIR filters and the synthesis FIR filters.

As can be seen from this discussion, the wavelet filter does not have an effect when all thresholds are set to zero, in which case the filter only provides a corresponding delay. The blocking effect of the thresholds increases with their increasing value.

The filter coefficients of the FIR I filters represent the employed wavelet. Each wavelet uniquely determines the coefficients for the filters HP, TP, iHP and iTP. Four coefficients are important for Daubechies-4-wavelets. All other values are generated by the mathematically-based permutation from these four numbers. The four FIR filters HP, TP, iHP and iTP form mathematically a so-called “quadrupole mirror filter” having specific properties.

The FIFOs employed as delay elements have different lengths. The lowermost FIFO stores the wavelet coefficients d5; the coefficients of the last stage d6 and a6 can be further processed directly. This FIFO must therefore compensate the group transit times of the FIR filters at the 6^{th} stage to prevent a phase offset. The delay in each stage must take into account the group transit time of the filter stage below and the cumulative delay of all stages below. FIG. 1 shows the filter structure in exemplary form for filtering employing stages.

The selection of the correct threshold value is important. The approach is initially oriented on the so-called “global threshold.” In this conventional method, the wavelet coefficients of a level are statistically evaluated by computing, for example, the standard deviation. This value is multiplied with a fixed factor known from publications to provide an estimate for an optimal threshold. This value is computed individually for each level.

This method is useful in a strictly mathematical sense only when “white noise” is present in addition to the useful signal, in which case it leads to an optimum result. However, such noise is typically not present in the signals obtained in nondestructive testing, and the term “colored noise” is used instead. Furthermore, the presence of coherent background signals makes the process more difficult, so that the process must be adapted.

According to the invention, instead of applying a fixed factor, the value can be freely selected by the operator, so that a specific filter strength can be selected. The threshold value for level i is: thr_i=sigma_i*f, wherein sigma_i is the standard deviation of the details in level i and f is the freely selectable factor (see FIG. 2).

The next problem is encountered when computing the standard deviation. In the conventional wavelet algorithm described above, the data are first divided into blocks and then transformed. A specific number of details is then generated for each block in each level, from which the standard deviation of the details can be computed. The entire process than becomes adaptive, because a new threshold is computed for each block.

This conventional process has two disadvantages. On one hand, the Adaptivity is very high, i.e. the thresholds vary quite strongly, producing an uneven filter effect. This is particularly disadvantageous in nondestructive testing, because the filtered values must here be evaluated, i.e. compared with fixed threshold values, in the test device. On the other hand, this form is difficult to reconcile with the continuous filtering according to the invention, because not each level has available the same number of data points and a standard deviation is difficult to compute point-by-point.

According to the invention, the standard deviation is therefore advantageously always computed at the last m-points, wherein m is an integer number corresponding to a number of measurement points. Advantageously, a large number is selected for m, which corresponds for example to the number of measurement points of one or several revolutions of the pipe. This value m can be adjusted and indicates the degree of the Adaptivity. If m is small, then the thresholds change frequently, whereas if m is large, the same threshold is used over a larger measurement range.

In contrast to conventional methods, the history of the measurement values is used to determine the actual threshold value. This approach is based on the reasonable assumption that the structure of noise and background signal does not change rapidly.

The aforedescribed method can be further improved by using an additional parameter alpha to dampen the changes in the automatically computed thresholds. This parameter alpha hereby dampens the Adaptivity by not allowing a new threshold thr_i_new to deviate too strongly upward or downward: thr_i_new<thr_i_alt*alpha (see FIG. 2).

As mentioned above, an estimate is required for the noise component of the signals in the individual levels; in addition, the standard deviation is typically computed. When the values do not have a DC component, it is sufficient to compute the “root mean square” (RMS) value. Advantageously, a method may be used for computing the standard deviation of the last m-values within a level, wherein not all of the last m-values are temporally stored, but a “running statistics” according to the formula below is used:

$${σ}^{2} = \frac{1}{N - 1} [ {\sum }_{i = 0}^{N - 1} {x}_{i}^{2} - \frac{1}{N} {( {\sum }_{i = 0}^{N - 1} {x}_{i} )}^{2} ]$$

It has been assumed so far that the measurement values are present as a “quasi-infinite” series; however, each test is finite. If the filters would continue to operate beyond the end of the test object or after the end of the measurement, then this would change the thresholds because the noise-signal structure is different during test pauses from that during the measurement. The test pauses are therefore advantageously communicated to the filter by using an additional signal. The complete filtering is stopped during this time, or at least the algorithm computing the thresholds is stopped. The beginning of a new test object is then initially tested by using the same thresholds as at the end of the preceding object. Instead of the beginning and the end of the test object, the test cycle, for example ultrasound pulse=A-image, can be adjusted and/or indicated by a trigger signal.

The sampling rate used to supply the signals to the filter and the number of stages (levels) of the filters are fundamentally important. These parameters depend strongly on the specific situation and can also be made adjustable according to the invention. The filter can then be still further parameterized. Advantageously, when coherent background signals are present, the number of the stages and the sampling rate can be selected to be high enough so that the background signal essentially remains only in the so-called Approximation. In this situation, unlike in the state-of-the-art, the Approximation is completely removed before the back-transformation, i.e. set to zero.

According to this description, the method according to the invention can be used for all measurement signals having “events” in form of pulses. In nondestructive testing, this applies inter alia to the magnetic leakage flux test, the ultrasound test as well as the eddy current test, wherein in the last case the audio-frequency signals are to be filtered with wavelets.

The aforedescribed algorithms can be programmed on conventional computer hardware, on dedicated signal processors (DSP) or in hardware in configurable logic components (e.g. FPGA).

### TERMINOLOGY

Input—Input signal

### HP—High-pass

### TP—Low-pass

### Delay—Delay

### Level—Stage

Output—Output signal
Length of history—Length of history

### Factor—Factor

Statistical calculation—Statistical evaluation
Threshold—Threshold value

1.-17. (canceled)

18. A method for filtering measurement signals by wavelet-filtering, comprising the steps of:
transforming the measurement signals into a wavelet domain with a wavelet transformation,
performing a threshold analysis using threshold values that can be varied in the wavelet domain depending on a measurement situation,
filtering the measurement signals by applying a plurality of filters arranged in segmentation levels,
computing a statistical parameter from an adjustable number of previously computed wavelet coefficients of a segmentation level,
and determining a threshold value for the segmentation level by multiplying the statistical parameter with an adjustable value that is common for all segmentation levels.

19. The method of claim 18, wherein the wavelet transformation and an inverse wavelet transformation of the measurement signals is performed with a continuous digital data stream.

20. The method of claim 18, wherein the measurement signals are wavelet-filtered with a cascaded arrangement of filters.

21. The method of claim 20, wherein the wavelet transformation and an inverse wavelet transformation of the measurement signals is performed with FIR (Finite Impulse Response) filters.

22. The method of claim 18, further comprising limiting a maximum value of the difference between sequential threshold values when computing the threshold value.

23. The method of claim 18, further comprising the steps of:
stopping filtering of the measurement signals during a measurement pause by applying at least one additional signal, and
making data of a previous measurement are available as history when measurements resume.

24. The method of claim 23, wherein a start or an end of the measurement pause is indicated by the at least one additional signal, thereby specifying a length of the measurement pause.

25. The method of claim 18, wherein in an n-stage wavelet segmentation, a longest-wavelength component of the signal referred to as approximation is also supplied for evaluating a threshold value.

26. The method of claim 25, wherein the approximation is set to zero.

27. The method of claim 18, wherein the statistical parameter is computed using a standard deviation from a mean.

28. The method of claim 18, wherein the statistical parameter is computed from a root-mean-square (RMS) value.

29. The method of claim 18, wherein the statistical parameter is computed using a standard deviation from a median.

30. The method of claim 18, wherein the plurality of filters can be adapted by freely selecting a sampling rate as parameter.

31. The method of claim 18, wherein a number of the segmentation levels is freely selectable.

32. The method of claim 18, wherein wavelets applied for filtering the measurement signals are freely selectable.

33. The method of claim 18, wherein “hard-thresholding” or “soft-thresholding” is used for changing wavelet coefficients when performing the threshold analysis.

34. The method of claim 18, wherein the wavelet transformation and an inverse wavelet transformation of the measurement signals is performed by using a “stationary wavelet transformation”.
